(19) United States
(12) Patent Application Publication
(10) Pub. No.: US 2020/0129799 A1
(43) Pub. Date: Apr. 30, 2020

(54) Wild Fire Fighting Products and Associated Methods

(71) Applicant: Georgios Kontos, King, NC (US)

(72) Inventor: Georgios Kontos, King, NC (US)

(21) Appl. No.: 16/175,038

(22) Filed: Oct. 30, 2018

(51) Int. Cl. A62D 1/00; A62C 3/02; A62C 99/00

(52) U.S. Cl. CPC A62D 1/0007; A62C 99/0045; A62C 99/0027; A62C 3/0228

(57) ABSTRACT

The present invention relates to fire suppressant systems and methods for suppressing or extinguishing fires. These fires may be wild fires. It also relates to new methodologies that employ a fire suppression technique that allows for one to target particular areas of a fire. The methods and systems for effectively at least partially suppressing and/or extinguishing fires include the use of a container that will disappear/disintegrate when exposed to the fire allowing fire retardant materials contained in the container to be exposed to thereby suppressing or extinguishing the fire.

The present application claims priority under 35 USC 119(e) to U.S. Provisional Application No. 62/707,330 filed Oct. 30, 2017, the contents of which are incorporated by reference in its entirety.

### BACKGROUND OF THE INVENTION

It has been estimated that the forerunners of Homo sapiens used fire at least one million years ago. In material analyzed from the Wonderwerk Cave in South Africa, a massive cavern located near the edge of the Kalahari Desert, it has been found that in the cave occupied by Homo erectus one million years ago had plant ash and charred bone residues alongside stone tools used by this population. This finding made it clear that fire was used by Homo erectus in at least a limited way to eat food that had been foraged and/or captured and/or hunted. The fires may have also been used to ward off animals and to warm these early human relatives when nighttime temperatures dropped. The studies that were done on these caves showed that the plant ash and charred bone residue reached temperatures of about 700° C. meaning that the fires were generated by local grasses that were prevalent in the area. Scientists have speculated that the ability of these early human ancestors to eat meat probably increased the protein available in their diets allowing them to evolve in many ways, including having smaller guts and larger brains. As brain size increased, these humanoid ancestors began to find better and more efficient ways of using fire to continue to increase the foods available for eating, allowing these early humans to continue to evolve.

In contrast, the fossil evidence indicates that wild fires were prevalent on the earth about the time that terrestrial plants first made an appearance on the planet. This was about 420 million years ago. The earth is ideally suited to having forest (wild) fires because of a cover of carbon-rich vegetation, seasonally dry climates in many locations on the earth, the presence of atmospheric oxygen, and widespread lightning strikes and volcanic activity. As global warming occurs, weather patterns are expected to change in a way that makes forest fires more numerous, substantial, and deadly. Those areas that go through seasonal dry seasons will have elevated temperatures generating drier and more burnable vegetation. Thus, when a lightning strike occurs (or some other ignition of a fire) the drier brush will produce more violent and intense fires.

In 2017, the United States spent more than 2.7 billion dollars in an attempt to suppress wild fires. In addition, California spent almost $500 million and Montana $400 million to suppress wildfires in 2017. Estimates for the total cost to suppress wild fires (of both the federal and state governments) exceed $5 billion annually. Wild fires also kill people, and destroy property. Because the number of homes adjacent forests undergoes increases every year so that there are almost 43 million homes that are near forests, the costs continue to increase yearly. In 2017, it has been estimated that the cost to insurers in California to cover the cost of lost homes and property due to wild fires is on the order of 3 billion dollars. This is not to mention the costs associated with the loss of human life due to fighting the fires, and animal life due to the fires themselves. The costs associated with wildfires are likely to increase as the forest fires become more intense. The amount spent on fighting the fires will increase because the fires are becoming bigger and more deadly. The increase in homes built near the fires will only exacerbate the fiscal and human situation meaning that more and more is spent every year on fires and more human lives are lost in fighting the fires.

Past and current means of prevention, detection and suppression (i.e., fighting) wild fires include techniques such as controlled burning of areas to contain these wild fires. To minimize the damage from wild fires, the forest service and others permit limited burning or igniting smaller fires to minimize the amount of flammable material available for a potential wildfire. Moreover, vegetation may be burned periodically to maintain high species diversity and frequent burning of surface fuels limits fuel accumulation.

The United States, until the early 1960s believed that it was wise to suppress wildfires immediately after they started. This was due to the extensive destruction that was done by wildfires in the Peshtigo Fire of 1871 and the Great Fire of 1910. The Great Fire of 1910 resulted in a fire so intense in the Northwest that 78 people lost their lives fighting the fire and the smoke from the fire could be found in Denver and in central New York.

The California wildfires of 2018 include a series of wildfires that have burned across the state. At least 5,600 fires have burned an area of more than 1.1 million acres (4,461.30 km²), according to the California Department of Forestry and Fire Protection and the National Interagency Fire Center, as of Aug. 24, 2018. The active Mendocino Complex Fire has burned more than 450,000 acres (1,800 km2), becoming the largest complex fire in the state's history, with the complex's Ranch Fire surpassing the Thomas Fire to become California's single-largest modern wildfire.

As time has passed and as more ecological studies have been performed, the science of suppressing wildfires has moderated some. The current state of the art is that fires do not necessarily need to be suppressed immediately. However, because wildfires are becoming more severe and more prevalent, this thinking may be need to be balanced with new techniques that are able to more effectively and quickly suppress fires. Moreover, techniques that allow one to more effectively target specific fires spots are desired.

In any event, it will be necessary to continually improve methodologies employed to suppress fires. It would be beneficial if new techniques could be developed that are more effective in that they can target specific fire spots, reduce the cost due to human's losing their lives, yet at the same time be able to suppress the fire's flames. The instant application was developed with these goals in mind.

### BRIEF SUMMARY OF THE INVENTION

The present invention relates to new products and new methodologies of suppressing wildfires. In an embodiment, these methodologies employ a fire suppression technique that allows for one to target particular areas of a fire. The present invention further relates to methods and systems for effectively at least partially suppressing and/or extinguishing fires. The methods and systems of the present invention relate to the use of a container that will disappear/disintegrate when exposed to the fire allowing fire retardant materials contained therein to be exposed to (and suppress or extinguish) the fire.

### BRIEF DESCRIPTION OF THE SEVERAL VIEWS OF THE DRAWING

FIG. 1 shows the phase diagram of carbon dioxide.

FIG. 2 shows a perspective view of one embodiment of a container of the present invention with a compound therein.

FIG. 3 shows a perspective view of one embodiment of a container of the present invention without a compound contained therein.

### DETAILED DESCRIPTION OF THE INVENTION

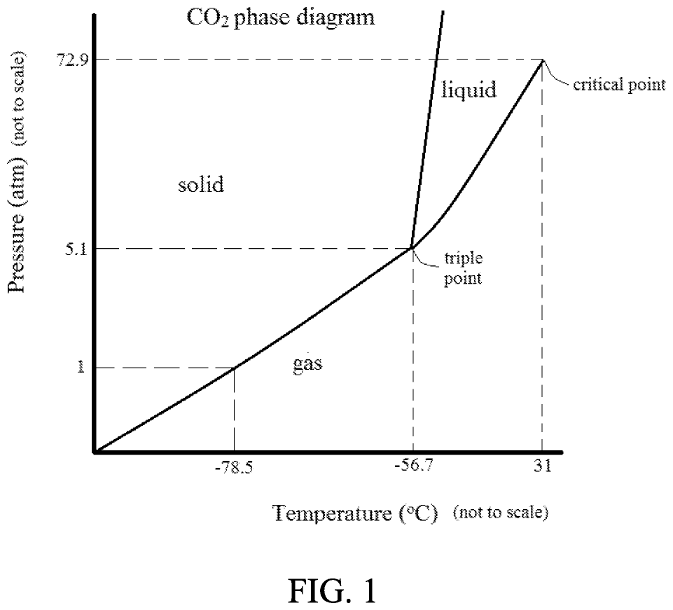

A phase diagram lays out the state that a given compound is in when it is subject to a given temperature and pressure. To change from one state to another state either requires the input of energy or the output of energy (i.e., energy is released) when the compound undergoes a phase transition from one state to another. Typically, when one goes from a solid state to a liquid state for a given compound, energy is required to change the state (called the energy of fusion) of that compound. When one goes from a solid state to a gaseous state (known as sublimation) energy is also required to effectuate the phase change (called enthalpy of sublimation). In contrast, energy is given off by the compound when it undergoes a phase transition from gaseous to solid (called deposition) or from gas to liquid (condensation). The phase diagram for carbon dioxide is shown as FIG. 1. At about one atmosphere pressure (the pressure that is typical of pressure at sea level on the surface of the earth), carbon dioxide sublimes as the temperature warms (i.e., it goes from a solid to a gas). In contrast, water at one atmosphere pressure goes from solid to liquid (melts) and then from liquid to gas (vaporizes) as the temperature warms. For a given quantity of carbon dioxide, energy is required to warm carbon dioxide in its solid state to a warmer solid state. As it undergoes the phase transition from a solid state to a gaseous state additional energy must be input for it to undergo this phase transition. The present invention takes advantage of the energy that comes from a wildfire heat to supply the requisite energy. Typically, if one is heating a solid compound at a constant rate, the temperature of the compound also rises at a constant rate until one reaches the phase change temperature (at a given pressure). When this point is reached, the heat energy continues to be added but rather than the compound continuing to increase in temperature, the energy is used for the phase transition between the solid and liquid or solid and gas (depends upon the phase diagram for the particular compound at the given pressure).

The present invention takes advantage of these phase transitions and the additional energy that must be input in order for a phase transition to occur. Thus, in an embodiment, the present invention relates to products and methods of using the phase transitions of compounds in order to suppress wildfires. In an embodiment, the present invention also relates to products and methods for being able to selectively target wildfire spots so as to suppress fire in that spot. In a variation, the products and methods of the present invention are related to a container that contains a compound or a series of compounds that undergo at least one phase transition when exposed to the wild fire. In an embodiment, the container is comprised of a material that disappears when exposed to the wild fire.

Because wildfire temperatures commonly reach the temperature of 800° C., it should be understood that the phase transition of the material placed in the container should be less than this temperature so as to undergo at least one phase transition. Moreover, the container should at least partially disappear or disintegrate at a temperature that is less than this temperature. That way, when the container containing the compound that undergoes the at least one phase transition is placed, lowered or dropped into the wildfire, the container will at least partially disappear or disintegrate and the compound contained therein will undergo at least one phase transition.

In one embodiment, the compound that undergoes the at least one phase transition will convert from a solid to a gas (i.e., sublime). In this embodiment, it should be understood that the compound in its gaseous phase will more effectively suppress or extinguish the fire than the same compound in its solid or liquid phase. In another embodiment, the phase transition may occur so that the solid goes first to the liquid phase (i.e., melt) and then to the gaseous phase (i.e., vaporize). In this embodiment, it should be understood that the compound in its liquid or gaseous phase will more effectively suppress or extinguish the fire than the same compound in its solid phase.

When the container at least partially disappears or disintegrates, it is meant that the container that contains the compound is no longer present so that the compound is available to be able to undergo the phase transition to at least partially suppress or extinguish the fire.

In an embodiment, the container may be any shape. The container may be cubic in shape or have some other box-like shape (e.g., wherein one of sides is longer and/or taller than another side). The container may be cylindrical, or cone-like in shape. It may have three sides, four sides, five sides (e.g., pentagonal), six sides (hexagonal), seven sides (heptagonal), eight sides (octagonal), nine sides (nonagonal), ten sides (decagonal) or more sides, such as eleven, twelve or more sides. In one embodiment, the container is box-like. In an embodiment, the container is cylindrical in shape.

In an embodiment, the container may be made out of two or more materials. In an embodiment, the top and bottom of the container may be made of one material and the sides of the container may be made of a separate material. In one embodiment, the sides may all be made of different materials. This affords the container the advantage of allowing some directionality for the container. For example, if one side of the container at least partially disappears or disintegrates prior to the other sides of the container (e.g., the container has at least one side that undergoes a physical state change before the others), that side of the container no longer serves as a barrier to the exposure of the compound thereby allowing the compound to start to undergo a phase transition on that particular side of the container.

As an example, if a container that is rectangular or square in shape in the top down dimension but also has some height (e.g., if it is square, the shape of the container will be like a cube) wherein the top and bottom are comprised of steel, three of the sides are aluminum and the other remaining side is cardboard, the steel top and bottom will not disappear or disintegrate when exposed to the wildfire, the cardboard side will undergo a relatively fast physical state transition wherein it goes from intact cardboard to a state that is eventually ashes. The aluminum may undergo an intermediate paced phase transition (depending on the temperature of the wild fire) wherein the aluminum goes from a solid to a liquid. In this embodiment, it should be clear that the side that contains the cardboard will be the first to disappear and/or disintegrate in the wildfire meaning that the compound that is in the container is left to undergo at least one phase transition wherein the compound can escape the container in a direction where the cardboard was. This provides some directionality to the container containing the compound.

For example, in one embodiment, the sides may be made of a material that differs from the material of the top and/or bottom. The sides may also be made of different materials to provide directionality to the container. In one embodiment, two different materials may be used in the container. In an embodiment, three, four, five or six different materials may be used in the container. When multiple materials are used, in one embodiment, these multiple materials may have vastly different physical properties so that they disappear, disintegrate, or undergo a phase change at different temperatures (and times) when exposed to the fire. In certain embodiments, some of the materials may not undergo any change when exposed to the fire.

In the above embodiment, it should be clear that by having a container containing a compound that can suppress or extinguish a fire in a given direction, the container can be effectively used where directionality is important. For example, if a wildfire approaches a home, the container can be dropped and/or placed in a direction wherein the fire suppression occurs principally in a direction that is away from the house and in a direction towards where the incoming fire may be approaching.

It should also be understood that the compound contained in the fire might also be comprised of a material that simply does not burn. Fire retardant materials have been used on furniture and these materials may be effectively used as the compound contained in the container. In this instance, these materials may create a physical barrier that allows one to protect a house. In one embodiment, the container might potentially be circular in shape with a hole in the middle (like a doughnut) to accommodate the size of the house so that it may be dropped from a plane (or placed around a home) so as to circumnavigate the home so as to prevent the home from burning.

In an embodiment, materials that may be used in the container of the present invention that will disintegrate or disappear are aluminum (with a melting point of 660° C.), certain aluminum alloys (melting point range 463-671° C.), aluminum bronze (600-665° C. melting point range), magnesium alloys (349-649° C. melting point range), zinc (419° C. melting point), zinc alloys (˜300-600° C. melting point range), cardboard, paper, wood, plastics, or other materials that disappear or disintegrate at a temperature that is below that of a typical wildfire (up to 800° C.). The container may also contain materials that will not disintegrate or disappear at a temperature that is below that of a typical wildfire (800° C.) such as brass, chromium containing alloys, cadmium containing alloys, cobalt containing alloys, copper or copper containing alloys, iron, manganese bronze, nickel, platinum, silver, or silver containing alloys, gold, steel, tantalum or tantalum containing alloys, or other materials that have high melting points. It should be recognized that unless the material undergoes a physical state change such as going from an intact state to an ashen state, the material in the container should be recoverable and usable again. Even if the material in the container melts, the melted material may be able to be recoverable and used again. In one embodiment, the container material should not be made of a material that is toxic to the environment or harmful to animals such as a material that includes arsenic, mercury, or lead.

Compounds that may be used that are present in the container may include carbon dioxide, water, nitrogen, argon or other inert gases, helium, various fluorocarbons such as bromochlorodifluoromethane and bromotrifluoromethane, some iron and phosphorous containing compounds.

It should be understood that the container may be also able to be pressurized either positively or negatively (so that it is substantially less than or more than atmospheric pressure) so as to contain a compound that is in a phase that it would not normally be in at normal atmospheric pressure (e.g., the phase that the compound is in at or near 1 atmosphere pressure or 760 Torr). Thus, when the container is exposed to the wildfire, one or more sides (or the top or bottom) may disappear exposing the compound that is contained in the container to a vastly different pressure, allowing the compound therein to undergo a phase transition.

It should be understood that in some instances, the reduced or enhanced pressure in the container may make the container somewhat explosive when exposed to the temperature of the wildfire. This explosive quality may be beneficially used to allow the rapid release of the compound contained in the container.

In an embodiment, although the invention in one application is designed to have a compound in the container that undergoes at least one phase transition, the compound in the container may additionally and/or alternatively contain a compound or material that is fire suppressive that does not undergo a phase transition at the given temperature and pressure of the wildfire and the pressure of the atmosphere where the wildfire is present. For example, the material contained in the container may be fire suppressive such as potassium and magnesium bicarbonate and/or sand (or silicon dioxide derivatives). In this instance, the material in the container may act to suppress the fire by smothering the fire. It should be understood that this fire suppressive material may be combined in a container with material that undergoes a phase transition.

In an embodiment, the material or compound in the container may be a combination of a plurality of materials, each with different physical properties that allow the at least partial extinguishment or suppression of the fire. These different properties of the plurality of materials may make the container a very effective way at extinguishing the fire. For example, in one embodiment, one of the compounds in the container may undergo a phase change with another compound contained in the container that does not undergo a phase change. For example, dry ice (solid carbon dioxide) may be used with sand, in addition to a slightly explosive compound. The dry ice is designed to undergo a phase change (solid to gas) when exposed to the fire, the slightly explosive compound is designed to explode when exposed to the heat from the fire thereby propelling the sand (and possibly the dry ice) onto the fire. The propellant (the explosive compound) may be designed in a manner that is similar to the design of fireworks (but with less propellant).

FIG. 1 shows a phase diagram of carbon dioxide, which is one of the compounds that can be used in the container of the instant invention. As can be seen in FIG. 1, when one is at one atmosphere pressure or a pressure that most closely approximates the pressure at the surface of the earth (near one atmosphere pressure), carbon dioxide is either a solid or a gas depending on the temperature. Much higher pressure is required for carbon dioxide to be in a liquid state. Nevertheless, if carbon dioxide is present as dry ice (e.g., a solid) in a container at around 1 atmosphere pressure and then subsequently exposed to a temperature that approximates what one would encounter in a wildfire, the carbon dioxide would go from a solid state to a gaseous state. Gaseous carbon dioxide is an effective fire suppressant so that when it is exposed to the fire, it will help suppress the fire. One of the ways that carbon dioxide is able to effectively suppress fires is due to competition with oxygen, thereby leading to a lack of oxygen feeding the fire. In this instance, combustion is no longer possible and the fire is effectively extinguished and/or suppressed.

It should be noted that by varying the pressure in the container (e.g., using very high pressure), one may be able to store the carbon dioxide in its liquid state. The phase change in this instance at these high pressures would be from liquid to gaseous after the carbon dioxide is exposed to the heat and the pressure of the wildfire.

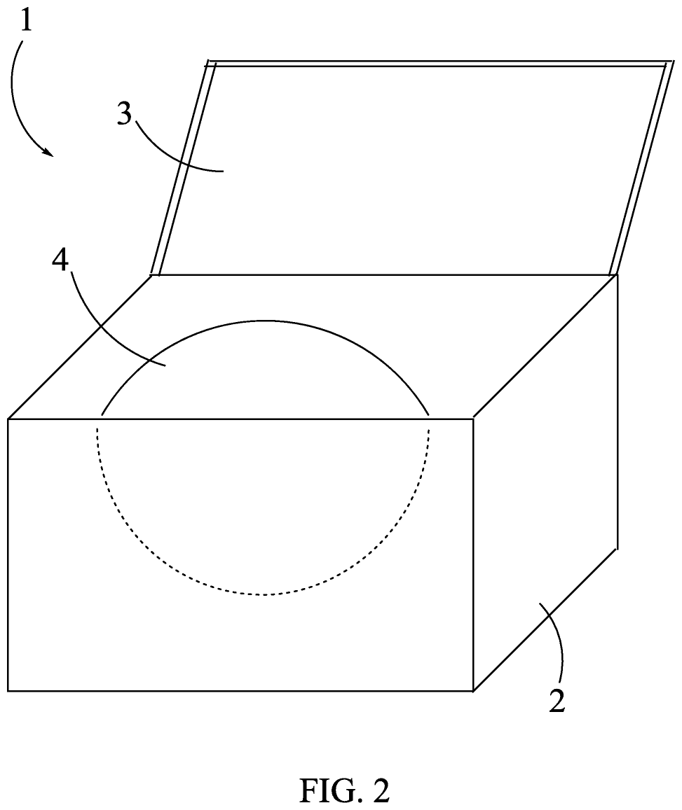

FIG. 2 shows a perspective view of a container 1 of the present invention with the fire suppressant compound 4 contained therein. The container comprises sides 2 and a top 3 and a bottom (not shown in the figure). In an embodiment and as shown in FIG. 2, the top 3 may be hinged so that the container can be closed to contain the compound 4. It should be noted that as explained herein, the compound 4 may include a plurality of different materials, with these different materials having different physical properties that allow the extinguishment of the suppression of the fire. It should be understood that although FIG. 2 does not necessarily distinguish the materials that are present as the sides and/or top and bottom, different sides may be made of different materials and the top and bottom may also be made of different materials as described supra.

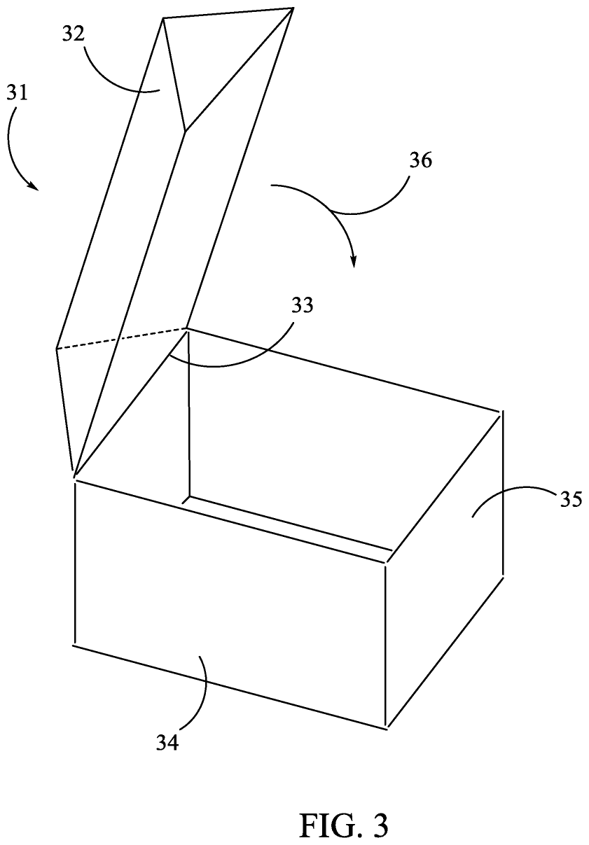

FIG. 3 shows a perspective view of a container 31 of the present invention without the fire suppressant compound contained therein. It should be noted that in this instance, there may be hinges 33 that allow the container top 32 to be closed in direction 36. As is shown in this figure, the top 32 might be a triangular shaped top that allows one to potentially add more material to the container 31 relative to a top that is flat (as, for example, is shown in FIG. 2) when the container is shut. Although the shape of the top 32 of this container is triangular, it should be understood that other shapes are contemplated and may be used with the compounds of the present invention. In this embodiment, shorter side 35 may be made of a different material than that of longer side 34 so that one side preferentially disintegrates/disappears more rapidly than the other side when exposed to the heat of the fire.

In an embodiment, the container shown in FIG. 3 may be insulated and/or have cooling capacity associated with it so that a second container (for example, that contained in FIG. 2) may be inserted into it thereby allowing the contents in the second container to remain at a temperature that keeps the compound contained therein in its solid state. In an embodiment, the container may also be constructed in a way so as to allow either higher or reduced pressure so that one can use the pressure to maintain the compound in its desired state. Alternatively, the container may contain both cooling ability and be able to withstand pressure extremes so that the combination of pressure and temperature keeps the compound at the desired temperature.

Although FIG. 3 is shown with an opening with hinges, it should be understood that the container may not have an opening associated with it. For example, the top of the container may be glued, nailed, screwed, welded, soldered, or have some other means of sealing the container after the addition of the compound so that the so the container does not risk opening prematurely, for example, if it is dropped from a plane into a wildfire. In one embodiment, the container should remain sealed completely until the container disintegrates and/or disappears thereby exposing the compound contained therein to the fire.

### Example 1

A fire was lit in a 55 gallon drum and allowed to burn to a capacity that filled the entire interior of the drum. A block of dry ice (solid CO₂) was dropped into the drum and on to the fire. During the sublimation of the dry ice from its solid state to its gaseous state, the fire was effectively extinguished. Without being bound by theory, it was believed that the carbon dioxide out competed the oxygen necessary to keep the fire combustible.

### Example 2

An uncontained fire was lit on private property with sufficient fire feeding material so that the fire would burn for a long period of time. The fire was allowed to spread and subsequently, blocks of dry ice encased in containers made of wood, were strategically placed throughout the fire. The fire burned (e.g., deteriorated) the wood containers so that the dry ice was exposed to the fire. The subsequent release of the gaseous CO₂ caused the fire to be extinguished. Without being bound by theory, it was believed that the carbon dioxide out competed the oxygen necessary to keep the fire combustible.

In an embodiment, the present invention relates to a fire suppressant system and methods of battling wildfires comprising using the containers and compounds as disclosed herein. In an embodiment, the present invention relates to a method of at least partially suppressing a fire, said method comprising combining at least one compound that undergoes at least one phase transition when exposed to energy from said fire with a container that contains said at least one compound, wherein the container containing said at least one compound is placed and/or dropped in said fire causing the container to at least partially disappear or disintegrate and the at least one compound undergoing at least one phase transition being exposed to the fire, thereby at least partially suppressing the fire. In one embodiment of the invention, the at least one phase transition is from a solid to a gas. Alternatively, the phase transition is from a solid to a liquid or from a liquid to a gas. In one embodiment, the at least one phase transition is directly from a solid to a gas (meaning that no phase transition through the liquid phase occurs).

It should be understood that an additional phase is the plasma phase of a compound (usually seen at the critical point, which is usually at a very high temperature and pressure), and for certain compounds, the plasma phase may be useful for suppressing fires.

In an embodiment, the methods and systems of the present invention relate to at least one phase transition that is a pathway from a solid to a liquid to a gas. In one embodiment, the compound in the container may be carbon dioxide. In one embodiment, the container may be made of at least two different materials. In one embodiment, the container comprises metal, wood, and/or cardboard. In an embodiment, the sides of the container may be made of cardboard or wood and a top and a bottom of the container may comprise a metal.

In an embodiment, the metal may be one or more of steel, brass, chromium containing alloys, cadmium containing alloys, cobalt containing alloys, copper or copper containing alloys, iron, manganese bronze, nickel, platinum, silver, or silver containing alloys, gold, tantalum or tantalum containing alloys.

In a variation, one side may be cardboard or wood and the other sides of the container may be wood or metal. In an embodiment, the metal may be one or more members selected from the group consisting of steel, aluminum, aluminum alloys, aluminum bronze, magnesium alloys, zinc, and zinc alloys.

In one embodiment, the container may further comprise paper, wood, or plastics.

In an embodiment, the present invention relates to a fire suppressing system, said fire suppressing system comprising a container and a compound contained in said container, said container designed to at least partially degrade when exposed to a fire thereby exposing said compound to said fire, wherein said compound is a compound that is designed to undergo at least one phase change when exposed to said fire.

In one embodiment, the container is sufficiently rigorous so that it can be dropped from a plane into a wild fire without breaking. In an embodiment, it is the heat from the wild fire that causes at least a part of the container to disintegrate/disappear thereby allowing the compound contained in the container to be exposed to the fire, thereby at least partially extinguishing/suppressing the fire.

In an embodiment, the compound may be carbon dioxide, water, nitrogen, argon or other inert gases, helium, bromochlorodifluoromethane, bromotrifluoromethane, or an iron or phosphorous containing compound. In an embodiment, the compound may be carbon dioxide.

In an embodiment, at least a part of the container may comprise cardboard or a metal containing alloy or metal with a melting point that is below 800° C.

In an embodiment, the container may further comprise paper, wood, or plastics.

In an embodiment, the fire suppressing system further comprises a fire suppressing compound that is a solid that does not and is not designed to undergo a phase change when exposed to the fire.

In an embodiment, the fire suppressing system comprises a container wherein the sides of the container are made of cardboard and the top and the bottom of the container comprise a metal. The top may contain a metal that is designed to disappear/disintegrate (e.g., melt) when exposed to the fire and the bottom may contain a metal that is not designed to disappear/disintegrate when exposed to the fire. For example, the top may comprise an aluminum alloy whereas the bottom may comprise steel

In an embodiment, the metal comprises one or more members selected from the group consisting of steel, aluminum, aluminum alloys, aluminum bronze, magnesium alloys, zinc, and zinc alloys.

It should be understood that there may be additional materials that may be used in the container such as different carbon fiber materials or other materials such as graphite. These carbon fibers may be ideally suited for use in the invention including properties such as high stiffness, high tensile strength, low weight, high chemical resistance, high temperature tolerance and low thermal expansion.

In one embodiment, the present invention relates to methods of inserting the container containing the compound into the fire. The container may be dropped from a plane during the fighting of a wildfire. The container may be placed into a fire that is burning or it may be placed in a location where the fire has not yet arrived (but will soon or eventually arrive). The use of cranes and/or drones and/or other means of placing the container in the fire without endangering fire fighters is contemplated. The strategic placement of one or more containers containing the compound(s) will allow those fighting the fire to strategically alter the fire so as to effectively suppress and/or extinguish the fire. In one embodiment, a plurality of containers may be used so as to create a “wall” that prevents the fire from going further in a given direction. By the use of different materials in the container and the use of different compounds contained in the containers, one should be able to directionally suppress and/or extinguish the fire.

It should be understood that the present invention is not to be limited by the above description. Modifications can be made to the above without departing from the spirit and scope of the invention. It is contemplated and therefore within the scope of the present invention that any feature that is described above can be combined with any other feature that is described above (even if those features are not described together). Moreover, it should be understood that the present invention contemplates and it is therefore within the scope of the invention that any element that is described can be omitted from the system and/or methods of the present invention. In any event, the scope of protection to be afforded is to be determined by the claims which follow and the breadth of interpretation which the law allows.

I claim:

1. A method of at least partially suppressing a fire, said method comprising combining at least one compound that undergoes at least one phase transition when exposed to energy from said fire with a container that contains said at least one compound, wherein said container containing said at least one compound is placed and/or dropped in said fire causing said container to at least partially disappear or disintegrate and said at least one compound undergoing at least one phase transition being exposed to the fire, thereby at least partially suppressing the fire.

2. The method of claim 1, wherein said at least one phase transition is from a solid to a gas.

3. The method of claim 2, wherein said at least one phase transition is directly from a solid to a gas.

4. The method of claim 2, wherein said at least one phase transition is from a solid to a liquid to a gas.

5. The method of claim 1, wherein said compound is carbon dioxide.

6. The method of claim 1, wherein said container is made of at least two different materials.

7. The method of claim 6, wherein said container comprises metal, cardboard, and/or wood.

8. The method of claim 7, wherein sides of the container are made of wood and a top and a bottom of said container comprise a metal.

9. The method of claim 8, wherein said metal is steel, brass, chromium containing alloys, cadmium containing alloys, cobalt containing alloys, copper or copper containing alloys, iron, manganese bronze, nickel, platinum, silver, or silver containing alloys, gold, tantalum or tantalum containing alloys.

10. The method of claim 7, wherein one side is cardboard and other sides of the container are wood.

11. The method of claim 10, wherein said metal is one or more members selected from the group consisting of steel, aluminum, aluminum alloys, aluminum bronze, magnesium alloys, zinc, and zinc alloys.

12. The method of claim 7, wherein said container further comprises paper, wood, or plastics.

13. A fire suppressing system, said fire suppressing system comprising a container and a compound contained in said container, said container designed to at least partially degrade when exposed to a fire thereby exposing said compound to said fire, wherein said compound is a compound that is designed to undergo at least one phase change when exposed to said fire.

14. The fire suppressing system of claim 13, wherein said compound is carbon dioxide, water, nitrogen, argon or other inert gases, helium, bromochlorodifluoromethane, bromotrifluoromethane, or an iron or phosphorous containing compound.

15. The fire suppressing system of claim 13, wherein said compound is carbon dioxide.

16. The fire suppressing system of claim 13, wherein the container comprises cardboard or a metal containing alloy or metal with a melting point that is below 800° C.

17. The fire suppressing system of claim 13, wherein the container comprises metal, paper, wood, or plastics.

18. The fire suppressing system of claim 13, wherein the fire suppressing system further comprises a fire suppressing compound that is a solid and is not designed to undergo a phase change when exposed to said fire.

19. The fire suppressing system of claim 13, wherein the fire suppressing system comprises a container wherein sides of the container are made of cardboard and/or wood and a top and a bottom of said container comprise a metal.

20. The fire suppressing system of claim 19, wherein the metal comprises one or more members selected from the group consisting of steel, aluminum, aluminum alloys, aluminum bronze, magnesium alloys, zinc, and zinc alloys.
